(19) United States
(12) Patent Application Publication
(10) Pub. No.: US 2006/0235569 A1
(43) Pub. Date: Oct. 19, 2006

(54) Dispensing machine and method

(76) Inventor: Graham Watts, Longbeach (AU)

Correspondence Address: MCKEE, VOORHEES & SEASE, P.L.C., 801 GRAND AVENUE, SUITE 3200, DES MOINES, IA, 50309-2721, US

(21) Appl. No.: 10/380,458

(22) PCT Filed: Sep. 7, 2001
(86) PCT No.: PCT/AU01/01129

§ 371 Date: Aug. 6, 2003

(30) Foreign Application Priority Data
Sep. 12, 2000 (AU) PR 0066

(51) Int. Cl. G06F 17/00

(52) U.S. Cl. 700/237

(57) ABSTRACT

A dispensing machine (1) with a release mechanism for selectively dispensing an item to a user, including a device (20) which is actuable by for example a remote control (8) to selectively enable operation of the release mechanism, wherein the dispensing machine (1) is a cigarette machine for a venue, and a card is associated with the venue so that, once the card is identified, a user's age is assumed and the device (20) is actuated for an item to be dispensed.

### FIELD OF THE INVENTION

The present invention relates to a dispensing machine particularly, but not exclusively, to a machine for dispensing cigarette packs, and a method of dispensing.

### BACKGROUND OF THE INVENTION

Machines for dispensing cigarette packs are known which include a coin operated release mechanism for dispensing a cigarette pack chosen by a purchaser from a range of available brands by pressing an appropriate selection button following insertion of sufficient money into the machine.

A problem associated with such machines is that no control is exercised over the cigarette purchase and illegal purchase of cigarettes, such as by children, may occur.

The present invention seeks to address such a problem.

### SUMMARY OF THE INVENTION

In accordance with the present invention, there is provided a dispensing machine with a release mechanism for selectively dispensing an item to a user, including a device which is actuable to selectively enable operation of the release mechanism.

Preferably, the machine is provided with an associated authorisation unit for actuating the device upon completion of a check of user identification.

Preferably, identification is derived from a card of the user and the unit includes means for identifying the card.

Most preferably, the dispensing machine is for a venue, such as a gaming venue, and the card is associated with the venue so that, once the card is identified, a user's age is assumed and the device is actuated for an item to be dispensed.

Preferably, the device is actuable by a remote control.

Preferably, the device is arranged to enable the release mechanism for dispensing the item until a prescribed condition is satisfied.

Preferably, the prescribed condition is one of an elapsed period of time following the release mechanism being enabled, dispensing of an item or disablement of the device using the remote control.

Preferably, the dispensing machine includes a money slot coupled to a money hopper for receiving money inserted by the user for purchase of the item, arranged whereby passage of money between the slot and the hopper is prevented when the release mechanism is disabled.

Preferably, the machine includes a change return and money is passed from the slot directly to the return when the release mechanism is disabled.

In another aspect, there is provided a method for controlling a dispensing machine including enabling a release mechanism of the machine for dispensing an item to a user.

Preferably, the device is actuated upon completion of a check of user identification by an authorisation unit.

Preferably, identification is derived from a card of the user being inserted in a card reader.

Most preferably, the machine is for a venue, such as a gaming venue and the card is associated with the venue, the method including assuming a user's age once the card is identified and actuating the device to dispense an item.

Preferably, the method includes disabling the release mechanism when a prescribed condition is satisfied.

Preferably, the prescribed condition is one of an elapsed period of time following the release mechanism being enabled, dispensing an item or actuation of a disablement function using a remote control.

Preferably, the machine is a cigarette dispensing machine and the item is a cigarette pack.

### BRIEF DESCRIPTION OF THE DRAWINGS

The invention is described in more detail with reference to the accompanying drawings, in which:

FIG. 1 is a diagrammatic perspective view of a dispensing machine; and

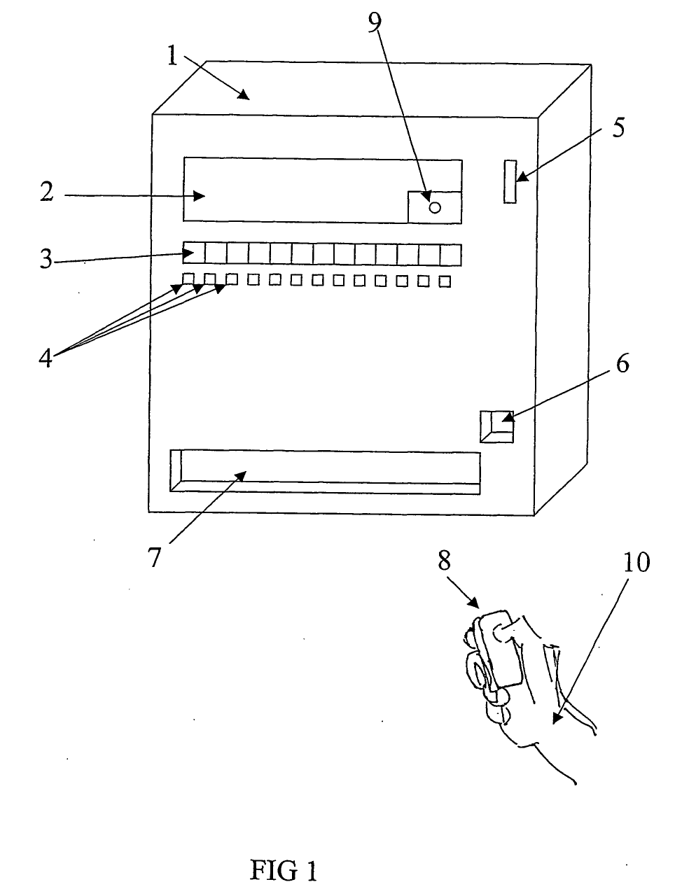

FIG. 2 is a schematic layout, illustrating operation of a device of the machine.

### DETAILED DESCRIPTION

A dispensing machine 1, in the form of a cigarette dispensing machine, is shown as including a general information display panel 2, a display 3 showing a variety of different cigarette packs which are available for purchase and a number of associated selection buttons 4 which may be depressed to indicate a selection of a particular cigarette pack. The machine also includes a money slot 5 for receiving coins which are passed to a hopper (not shown) arranged internally of the machine1. A coin return 6 is also provided for refunding the whole or part of any coins introduced into the slot 5, as appropriate. An opening 7 is provided adjacent a base of the dispensing machine 1 into which a purchased packet of cigarettes is dispensed for collection by the user.

In operation, a sufficient amount of money is introduced into the slot 5 and a particular brand of cigarettes is chosen by pushing one of the buttons 4, at which time a release mechanism dispenses a single pack of cigarettes down in to the opening 7 and refunds any spare change into return 6.

The dispensing machine 1 further includes a device (not shown) which may be remotely actuated by, for example, a remote control 8 to selectively enable the release mechanism. When the release mechanism is disabled, the passage of money from the slot 5 to the hopper is prevented and the money is instead passed directly to the return 6. An indicator light 9 is also provided on the machine to indicate the disabled condition of the release mechanism. A user of the machine, upon noticing the light 9 may then approach an authorised person 10, such as a bartender or shopkeeper who may then actuate the remote control in order to enable the release mechanism. The user is then free to slot money in the machine for purchase of a selected cigarette pack. The device may then be reengaged to disable the release mechanism when a prescribed condition is satisfied. The relevant prescribed condition may be one of the release mechanism dispensing the item, a period of time elapsing since the release mechanism was enabled or actuation of a disablement function using the remote control 8 itself.

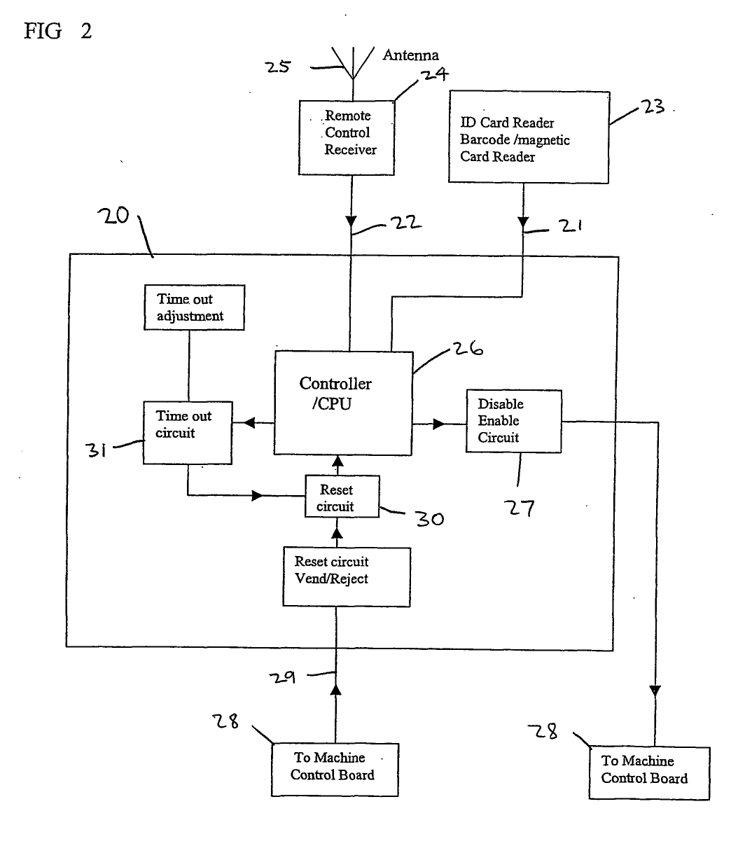

The operation of the device is described in more detail with reference to FIG. 2, wherein the device 20 is shown as receiving inputs 21, 22 from either an authorisation unit 23 or a remote control receiver 24, which communicates with the remote control 8 via antenna 25. The inputs 21, 22 are coupled to a controller/CPU 26 of the device 20 which in turn is coupled to a disable/enable circuit 27, for controlling dispensing operation of the machine 1 via a machine control board 28. When a signal is received from the remote control 8, the CPU 26 selectively enables operation of the release mechanism, as appropriate, by way of circuit 27. Alternatively, a user may present some form of identification to the authorisation unit 23 in order to establish they are of a suitable age to purchase cigarettes. For that purpose, the unit 23 includes means, such as a card reader, for identification purposes and identification is derived from a card carried by the user, which is swiped through the card reader. Such a card may, for example, be a membership card or gambling card at a gaming venue or the like, such that a certain minimum age may be assumed. In any event, once a user has been authorised, the controller 26 may be caused to allow a cigarette pack to be dispensed.

As mentioned above, the device may disable the release mechanism when a prescribed condition is satisfied. For example, the remote control 8 may be used to transmit a disable signal directly to the CPU 26. Alternatively, an input 29 may send a signal from the machine control board, indicating a cigarette pack has been dispensed. For that purpose, the input may be fed to a reset circuit 30 which then passes a relevant signal to the CPU 26 for disabling the release mechanism. A further alternative is for a time out circuit 31 to cause the reset circuit to send an appropriate signal to the CPU 26 after a predetermined period of time has elapsed after initial input of signals from either the remote control receiver 24 or authorisation unit 23. The predetermined period of the circuit 31 may be adjusted, as appropriate using a time out adjustment circuit 32.

As may be appreciated from the above, the present invention allows a degree of control over a conventional cigarette dispensing machine to address the problem of children purchasing cigarettes from such machines. It should also be appreciated, however, that the invention may also be applied to other forms of dispensing machines and need not necessarily be limited to machines for dispensing cigarettes.

The machine 1 and associated method of operating same have been described by way of non-limiting example only and many modifications and variations may be made thereto without departing from the spirit and scope of the invention as described.

1. A dispensing machine with a release mechanism for selectively dispensing an item to a user, including a device which is actuable to selectively enable operation of the release mechanism.

2. A dispensing machine as claimed in claim 1, with an associated authorisation unit for actuating the device upon completion of a check of user identification.

3. A dispensing machine as claimed in claim 2, wherein identification is derived from a card of the user and the unit includes means for identifying the card.

4. A dispensing machine as claimed in claim 3, wherein the dispensing machine is for a venue, such as a gaming venue, and the card is associated with the venue so that, once the card is identified, a user's age is assumed and the device is actuated for an item to be dispensed.

5. A dispensing machine as claimed in claim any one of claims 1 to 4, wherein the device is arranged to enable the release mechanism for dispensing the item until a prescribed condition is satisfied.

6. A dispensing machine as claimed in claim 5, wherein the prescribed condition is one of an elapsed period of time following the release mechanism being enabled or dispensing of an item.

7. A dispensing machine as claimed in any one of claims 1 to 4, wherein the device is actuable by a remote control.

8. A dispensing machine as claimed in claim 7, wherein the device is arranged to enable the release mechanism for dispensing the item until disablement of the device using the remote control.

9. A dispensing machine as claimed in any one of claims 1 to 8, wherein the dispensing machine includes a money slot coupled to a money hopper for receiving money inserted by the user for purchase of the item, arranged whereby passage of money between the slot and the hopper is prevented when the release mechanism is disabled.

10. A dispensing machine as claimed in claim 9, wherein the machine includes a change return and money is passed from the slot directly to the return when the release mechanism is disabled.

11. A dispensing machine as claimed in any one of claims 1 to 10, wherein the machine is a cigarette dispensing machine and the item is a cigarette pack.

12. A method for controlling a dispensing machine including enabling a release mechanism of the machine for dispensing an item to a user.

13. A method as claimed in claim 12, wherein the device is actuated upon completion of a check of user identification by an authorisation unit.

14. A method as claimed in claim 13, wherein identification is derived from a card of the user being inserted in a card reader.

15. A method as claimed in claim 13 or 14, wherein the machine is for a venue, such as a gaming venue and the card is associated with the venue, the method including assuming a user's age once the card is identified and actuating the device to dispense an item.

16. A method as claimed in any one of claims 12 to 15, including disabling the release mechanism when a prescribed condition is satisfied.

17. A method as claimed in claim 16, wherein the prescribed condition is one of an elapsed period of time following the release mechanism being enabled, dispensing an item or actuation of a disablement function using a remote control.

18. A method as claimed in any one of claims 12 to 17, wherein the machine is a cigarette dispensing machine and the item is a cigarette pack.
